(19) United States
(12) Patent Application Publication
(10) Pub. No.: US 2014/0130076 A1
(43) Pub. Date: May 8, 2014

(54) System and Method of Media Content Selection Using Adaptive Recommendation Engine

(71) Applicant: IMMERSIVE LABS, INC., New York, NY (US)

(72) Inventors: Stephen Moore, New York, NY (US); Jason Sosa, Holland, MI (US)

(21) Appl. No.: 14/069,933

(22) Filed: Nov. 1, 2013

Related U.S. Application Data
(60) Provisional application No. 61/722,698, filed on Nov. 5, 2012.
(60) Provisional application No. 61/793,493, filed on Mar. 15, 2013.

(51) Int. Cl. H04N 21/25; H04N 21/81; H04N 21/442

(52) U.S. Cl. CPC H04N 21/251; H04N 21/44218; H04N 21/812
USPC 725/19

(57) ABSTRACT

This is a system and method of providing selected media content whereby information about the characteristics or behavior of a person viewing the content viewer is detected or otherwise determined and then automatic feedback is used so that as such adjustments are made, the view behavior is further monitored in order to evaluate the quality of the adjustments and make further adjustments in order to meet a pre-determined objective.

### PRIORITY

This application claims priority as a non-provisional continuation of U.S. Provisional Patent Application No. 61/722,698 filed on Nov. 5, 2012 and as a non-provisional continuation of U.S. Provisional Patent Application No. 61/793,493 filed on Mar. 15, 2013, both of which are hereby incorporated by reference in their entireties.

### BACKGROUND AND SUMMARY OF THE INVENTION

This is a system and method of providing selected media content whereby information about the characteristics or behavior of a person viewing the content is detected or otherwise determined and then used to modify or adjust what will be selected to be presented as content. The system and method operate with automatic feedback so that as such adjustments are made, the view behavior is further monitored in order to evaluate the quality of the adjustments and make further adjustments in order to meet a pre-determined objective. The selection process itself is adapted to optimize one or more primary variables in a feedback process. The feedback process can occur in real-time. The feedback process also incorporates the use of other event data relevant to the process. In addition, the feedback process can automatically adjust the selection process to optimize one or more primary variables. In this way, the system is an event driven adaptive recommendation system for selecting media content to display.

In one embodiment, the system is comprised of an output device, typically a video display screen possibly with a loudspeaker, and an input sensor, typically a video camera possibly with a microphone that is observing the viewer of the screen and a computer operatively controlling the video display screen by selecting what content to display on the screen and at the same time, receiving video data from the video camera. In another embodiment, another computer, operatively connected to the first computer using a data network, will receive the video data and extract information about the viewer and store that information as event data. That event data is then transmitted to the first computer.

Additional event data can be received by the system separately from the video camera, including, without limitation, weather, location of the video display and video camera, day and time of day. Any data that is relevant to optimizing the one or more primary variables may be used as parameters in the selection process in combination with the event data. In one embodiment, the primary variable is the instantaneous sales revenue being generated at a retail location typically generated using point of sale computer devices operatively connected using a data network. This data can itself also serve as event data that feeds the first computer and as an input into the adjustment process.

The first computer uses the event data to determine what to display on the video screen. In the most general sense, the computer executes a process whose result is the selection of a piece of media for display. The input to this process is the event data and other parametric data. The process may rely on heuristic rules or methods to make the determination. The process is also designed to adjust the outputs in order to maximize the primary variable.

In one embodiment, the primary variable may be the amount of time the person viewing the video screen watches the screen before turning away. This is useful for advertising. The process then takes as input information about the viewer: their gender, likely age and any other detectable parameters. Other parameters are also stored, for example, weather, time of day, and the type of location that the video screen is operating in.

The process can use this data to determine which type of advertising to display that maximizes viewer engagement. In this embodiment, advertising content, typically an audiovisual clip, is referenced in a database that includes data about the advertisement: its owner, the type of product or service being advertised, when it was displayed, where it was displayed, the viewer engagement on each display, event data about the viewers in each instance of display, the weather for each display instance and the day and time of each display instance. The process can use this data to determine which advertisement is called for in the given location and the specific information about the viewer viewing the display at that time. This information can be considered a profile associated with the piece of advertising or other content. This profile, which may include information about viewing at one location, can be used to inform the selection process of advertising or other content at that or another location. The process extracts from the historical data which advertisement will provide the best engagement for that location, at that time, for that type of viewer. In addition, the resulting engagement by the viewer is stored for future use.

The feedback process is adjusted based on the observed data. For example, the historical data might demonstrate that an advertisement for a restaurant has the most viewer engagement between 10 am and 12 pm, while an advertisement for sports clothing does best between 4 pm and 6 pm on sunny, warm days. But at the same time, it may be that women respond to the sports advertising more than men, while men respond more to the restaurant advertisement. As a result of these heuristics mined from the data, the first computer can determine which advertisement of the two to show on the screen in order to maximize the primary variable of viewing time. If the event data indicates that the viewer is male and the parametric data is that it is 5 pm, then a restaurant advertisement is selected.

In the retail context, the primary variable may be entirely different, for example, the rate of revenue generation in a clothing store. In this case, the retailer may wish to have a sequence of advertising that presents particular styles and looks to the viewer. Based on correlations between rate of sales at a point of sale device in the retail location and the advertising selection displayed on the screen, the process will select the advertising to maximize the primary variable of the rate of revenue generation. As noted above, the event data derived from point of sale devices in one retail location may be used in another in order to determine what is to be displayed there.

In yet another embodiment, the advertising selections can also be determined based on whether a particular advertiser has bid on the display instance. In this embodiment, advertisers that are seeking a particular demographic, or other parametric situation where the advertising is considered most effective can purchase ad placement in those logical positions. For example, an advertisement for women's cosmetics may be most effective in the evenings at the end of the week, and displayed on billboards viewable during a commute home. In this instance, an advertiser for skin-cream may bid on that logical state: displays to women, on outbound locations leaving a city on Friday evenings from 4 pm to 7 pm. In this case, the advertiser can pay for the placement, or pay an amount related to how long the viewer views the advertisement. The payment may be related to the number of displays that actually occur. However, in this embodiment, because the system is event driven and adaptable, if a viewer at that time and location is a man, a different selection logic may apply to display an ad relevant to the man, for example an advertisement for Scotch.

In yet another embodiment, the system can be used with interactive television or other content selection services. Based on the viewer event data and other parametric data, the media items presented as available choices may be changed.

In yet another embodiment, the event data can be used for determining the restocking of inventory in an automatic delivery system, for example, an automated kiosk or similar vending machine.

In computer game interaction or interactive story-telling, the primary variable can be the type of expression of the viewer's face. The type of expression can also be used as a primary variable to maximize apparent satisfaction with automatic selection of content.

In yet another embodiment, the system can use the face image of the viewer for identification purposes. In this embodiment, a unique identifier is generated from the detected face of the viewer. The location of the camera is also stored with the identifier. The viewer can opt-in to the system and input their cell phone number by calling a telephone number displayed on the screen, which is answered automatically by a computer operatively connected to the system. This establishes an identity that can be further used by the viewer by tying their identity to a particular payment system.

In this embodiment, a purchase transaction at a retail location can be executed by means of the advertising viewing system in that location. When the viewer enters the store and selects merchandise, the system can execute payment without the viewer either presenting a credit card or a cell phone payment mechanism. The detection of the viewer's face in the system is sufficient. This can occur at the same time as the advertising system selects what advertisements to present based on the parametric data representing the purchase transaction history associated with that viewer and other parametric data.

In yet another embodiment, the viewer may not opt-in. In this case, the viewer may be anonymous, although recognizable by the system as having a particular identifier associated with their face. In this embodiment, the identity of the viewer is itself event data that is used to select advertising for display. For example, the system may recognize that a particular unique viewer has shopped and purchased a bathing suit and sun-glasses in December, and in the northern hemisphere, i.e. winter. As a result, the feedback system determines that the advertising that maximizes revenue at a drug-store location in this situation is the sale of high-end sun-screen products and skin moisturizers for use on vacation. The selection of advertising may then display these products with a reminder that it is better to buy these at home rather than hope to find them on a remote vacation island.

One way that the system can determine what to display is to use the random forest technique of mining data in order to maximize a variable in or associated with the data. However, many other kinds of machine learning or artificial intelligence heuristic programming techniques may be used. In yet another embodiment, linear programming or chi-square correlation may be used to correlate variables with the primary variable.

The system is comprised of at least one video display device, which may further comprise one or more corresponding loudspeakers which is operatively connected to a first computer, typically using a data network. The one or more video display devices may be driven by corresponding one or more computers that receives data from the first computer and then operates the corresponding display device. The system is further comprised of one or more video cameras, which may further be comprised of one or more corresponding microphones. The cameras and microphones may be operated by another one or more corresponding computers that transmit data generated from the video or audio inputs.

The first computer is also operatively connected to a database that contains the stored event data and other parametric data, typically using a data network. The data base also contains the stored media content profiles. The data base also stores data about viewers, for example, their identifiers, face recognition data, purchase history, viewing history and event data associated with those views.

The system may be further comprised of a point of sale device that receives one or more transaction data values that can be associated with a viewer's event data or stored as event data in the database. The system may also be comprised of a mobile telephone transmission network and at least one mobile telephone associated with at least one viewer of the display screen.

It is understood that the processes described as occurring in one computer could be separated into sub-processes executed by different computers that are operatively connected. It is understood that a single database containing more than one type of data could be separated into more than one database and the more than one databases used in concert to provide data to the one or more computers that execute the invention or comprise the invented system.

### BRIEF DESCRIPTION OF THE DRAWINGS

FIG. 1: Schematic of DIMA architecture providing feedback.

FIG. 2: Example of feedback using a decision tree with a primary variable of attention time.

FIG. 3. Example of feedback engine using N element vectors. The blue colored feature vectors in a defined subspace maximize attention time for Male adults. The red colored feature vector maximize attention time for female seniors and the green vectors maximize attention time for young adult males.

FIG. 4. Basic architectural schematic and user interface.

FIG. 5: Example display with facial recognition sensor.

FIG. 6: Example System Architecture

FIG. 7: Example Flow Chart

### DETAILED DESCRIPTION OF THE PREFERRED EMBODIMENTS

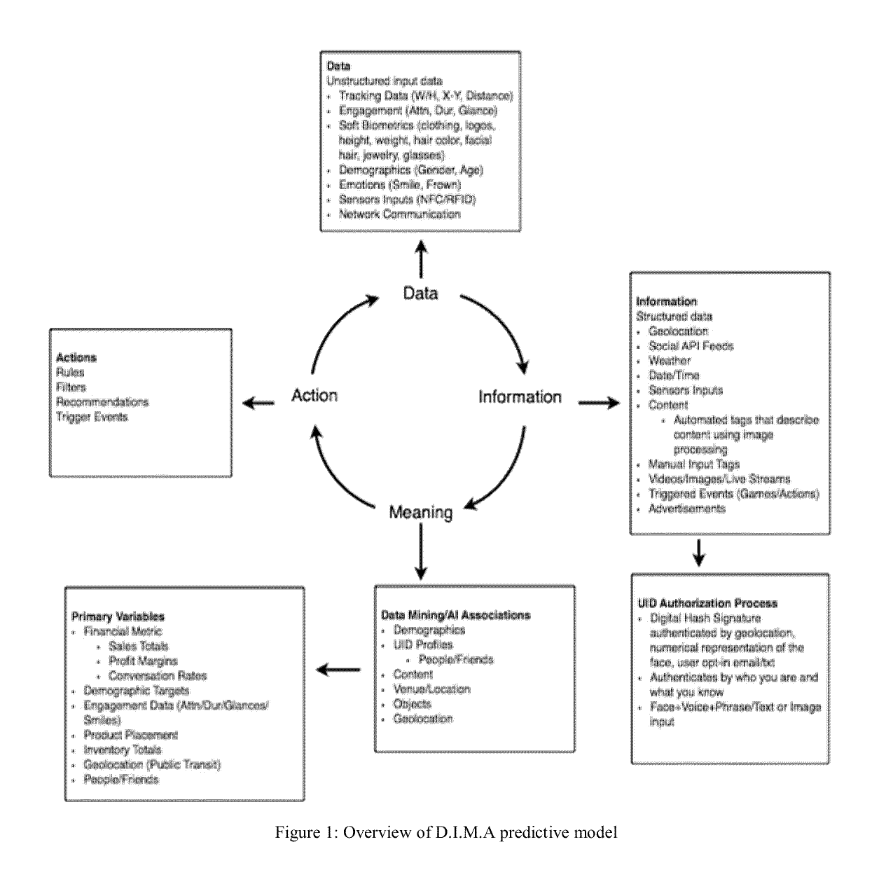

This involves a predictive model for event driven actions using audience analytics gathered by a sensor, unstructured data and/or structured data from other sources as shown in FIG. 1. This system is a process for intelligent two-way communication (variable or non-variable) between content, objects, persons or environments with an another user using anonymous or Unique ID. The system embodies:

Data mining/AI to find actionable business value from data to make decisions within a system

Learning system using a predictive model method from structured and unstructured data to create a database of associations and probabilities to determine an action or triggered event within a system

Feed forward and back propagation learning system

1. Data

Unstructured input data and provided by camera and other sensors in real world environments. This data can be captured by image processing, computer vision and AI techniques, including:

Tracking Data (position of user relative to sensor, distance to sensor)

Engagement Data (attention time, duration and/or number of glances of user)

Soft biometrics (height, weight, hair color, jewelry, brand logos)

Demographics (gender, age, ethnicity)

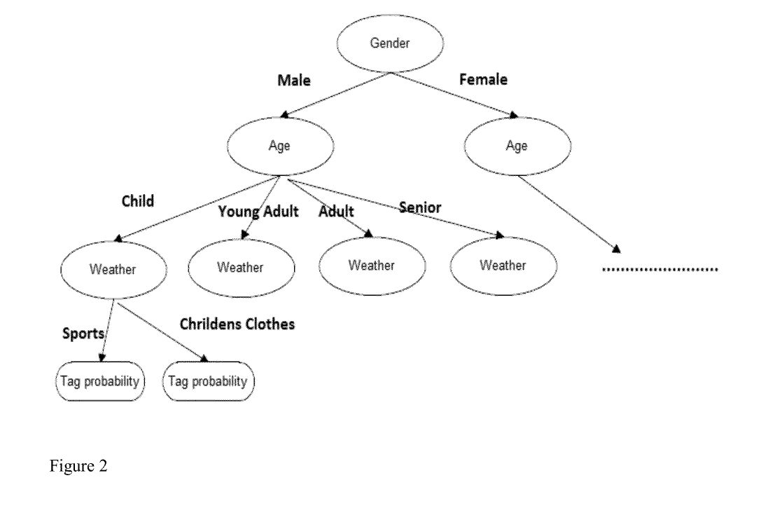

User Opt-in UID (see method below—FIG. 2)

Emotions (smile, frown, neutral, sad, anger, disgust, fear, confusion, interest, and other mental states and emotions)

Sensors Inputs (NFC/RFID/IR/QR)

Internal or external network communication

2. Information

Structured data, variables and external parameters can be combined in a useful way with the unstructured sensory data including:

Geolocation/Geofence

Social API Feeds

Weather

Date/Time

Sensors Inputs

Content

Automated tagging method that describes content using image processing

Manual Input Tags

Videos/Images/Live Streams

Triggered Events (Games/Actions)

Advertisements

2.1 UID Authorization Process

A triple authentication opt-in method using face recognition/biometric data is used to allow authorized access to third parties of personal information via sensors in physical locations, devices, objects and payments approval. These processes include:

1 Digital biometric signatures creating a numerical representation of the face via a camera sensor

2 Authenticated identifiers with geolocation or geo-fence

3 User opt-in by means of email, text or voice verification using a mobile or wearable computing device

Originating location data encoded into biometric verification as proof of authorization event

Several advantages of the authentication process may be obtained:

Allows for quick and efficient biometric check-ins, passport verification, third party access to private data, passive “pay-by-face” payments, other user login authorization

User can set permissions based on geolocation and third party approval process

Authenticates user by face print (who you are), geolocation (where you were when you gave permission) and email/txt verification (what you know)

Permissions can be tied to a geo-fence. Example: Starbucks on 3rd Ave can have permission to use my face for advertisements in exchange for a 10% discount off my coffee purchase, however the Starbucks on 34th St cannot.

Additionally data could be included to verify authentication in any combination (e.g. face, voice, phrase, text, image input, location)

Permissions are managed and maintained by the user through a web based portal. User can define permissions, preferences, authorized locations, applications, and third party users

These permissions may trigger an event or affect a unique message via a wearable (or biologically embedded) augmented overlay vision system or mobile device

User can add the UID (numerical representation of face data) to a do not track database and block other users, advertisers, applications, etc

User has the ability to completely remove themselves from the system at any time

3. Meaning

The purpose of the Meaning component of the system is to gather the information, analyze it in different ways so as to make or find recommendations and or business value from the data. Machine learning techniques, artificial intelligence and or data mining algorithms can be used to analyse the data from the Data stage and the information stage of the system. Primary variables as listed below can be used for learning relationships in order to produce certain outcomes. Such techniques would include but not limited to random forests, ferns, boosting, support vector machines, neural networks, regression techniques, Bayes networks and other probabilistic based approaches and or data mining techniques.

3.1 Primary Variables

The primary variable affects the action of triggered events that produces a final outcome. Example: The user, marketer, advertiser can specify a primary variable—the rules or preferences based on the outcome they wish to achieve (i.e increased sales, content recommendations, increased attention time, higher % of demographic specific watchers, overstock of specific inventory, etc). The primary variable can include any of the following:

Financial Metric

Demographic Targets

Engagement Data (attention time of user/users, duration of user, number of glances, expression classification)

Inventory

Geolocation (Public Transit advertising can use geolocation data to change in vehicle messages based on neighborhood)

Social engagements—People/Friends

Content

3.2 Profile Associations

The Profile Associations are a database of relationships between the following.

Demographics

Engagement

Other User Profiles

Content/Advertisements

Venue/Location

Physical Objects

People/Friends

Unique ID's

4. Actions

The triggered execution of actions, rules and filters based on use cases. Decisions are applied to text, audio, video, images, sound, curriculum, gaming, physical objects, augmented reality overlays and other triggered events.

Rules (frequency limitation of content that can be displayed based on price bidding within a specified period of time)

Filters (display event based on specific emotions or demographics)

Recommendations (suggestions based on learned patterns across profile associations)

Trigger Events (a physical, electronic, content related event or augmented display message)

Pricing (Pay-per-look, automatic ad insertion and real-time bidding (RTB)

Actions can be based on simple or learned triggers that are based on variables or via a learned relationship between profiles associations (unstructured or structured data). Example: if the primary variable is “gender” then content on digital signs can be changed automatically depending on the current gender classification of the users in the scene. Actions can be based on the output of a probability engine on the best content to play next. Action can be alter digital content based on expression of the user, etc.

System Capabilities:

Personalization—based on primary variables

Deletion—using image/object recognition to remove offending content

Automation

Analytics collection

Adaptive events

Tracking motions

Engagement analysis

Human Computer Interaction

Components and Unique Combination

All use cases are based on the unique combination of the following components that leverage the DIMA predictive model as listed below.

1 Computer Vision Based Face Detection/Recognition

2 Machine Learning Predictive Model (FIG. 1: DIMA)

3 Analytics collection using a camera sensor

4 Unique ID Process (FIG. 2: UID)

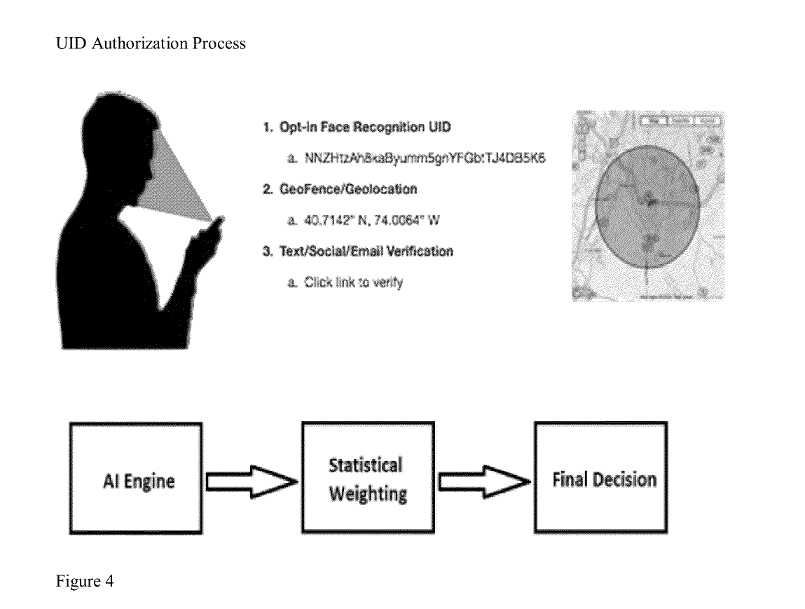

5 Event Driven Content (Intelligent Personalization FIG. 4: Avatar Sim)

There a number of example embodiments, presented below as different use cases that employ the invention:

Use Cases:

Tablets/Smartphones

Adaptive advertising on a device providing recommendations based on camera sensor

App analytics provides demographic and engagement data to a third party via a remote server using a front facing camera sensor

HCI Gaming interactions using facial features, engagement data, head tracking, perspective tracking and emotion expression.

Wearable computers

Identification or profile data of individuals provided to the wearer of a computing device equipped with a sensor using facial recognition. Predictive model allows for content and personalized recommendation based on user permissions historical information and/or third party data feeds.

Desktop Computers

Web camera embedded into a local desktop/laptop computer allowing for analysis of emotion, demographics and UID to a third party for the purposes of collecting analytics and recommending personalized content.

Browsers

Using a camera sensor and a web browser to allow for analysis of emotion, demographics and UID that is given to a third party for the purposes of collecting analytics and recommending personalized content via a tablet, ebook reader, wearable computing device or biologically implanted system that allows for user interaction.

Digital Signs

Digital display equipped with a webcam, CPU and internet connection. The sensor gathers data from the person(s), demographics, venue location, weather, external APIs and checks available content options (Locally/server side) to deliver an event-based message in real-time that best matches the user/scenario. The content selection process is based on the D.I.M.A predictive model. The desired content or outcome is selected by the marketer, user or authorized third party using a primary variable (e.g. attention time, demographics, recommendations, inventory, etc) and other rules that affects the outcome of the event selection.

SmartTV Viewing Recommendations

Using anonymous demographic data or UID we create user profiles based on TV programming and commercial ad placement. As an example user A prefers to watch cooking shows, user B prefers to watch business shows. The recommendation engine will look for common matches (categorized in a menu system) between the individual preferences of user A and user B to recommend content matches that both may enjoy.

Adaptive Commercials

Customized commercials based on demographics, location as described in the smart advertisement use case description below.

Recommended matches for search engines.

Emotion

Demographics

Family members

Sync media content based on face

Authorization to sync content, settings, or preferences based on the face of the user across various devices and locations

Pay with face

Similar to the one touch purchase button from amazon.com, this method allows users to preassign permissions to third parties (see FIG. 2: UID) enabling a fast and seamless pay-with-face option for online and/or in physical bricks and mortar stores

Share with face

Method that allows users to preassign permissions to third parties (see FIG. 2: UID) enabling a fast and seamless share-with-face option for online and/or in physical bricks and mortar stores

Energy optimization if no face is detected

Self-service Kiosks

Dynamic interaction with a self-service kiosk including recommendations to products/services based on demographics, number of people and environment/location. Changing the external lighting or displays to attract or retain the audience attention, providing an incentive credit or coupon based on interactions

Vending Machines

Vending machine equipped with a webcam, CPU and internet connection. The sensor gathers data from the person(s), demographics, venue location, weather, external APIs and matches to an item being purchased through a touch sensor or push button. The machine inventory can now be predicted based on the D.I.M.A predictive model. If the vending machine is equipped with a display then a targeted message will appear based on previous user interaction or purchases. The desired content or outcome is selected by the marketer, user or authorized third party using a primary variable (e.g. attention time, demographics, recommendations, inventory, etc) and other rules that affects the outcome of the event selection.

Interactive Mirrors

Mirrors that reflect the image of a person likeness in addition to augmented content in a way that is personalized using a camera sensor.

Augmented or Virtual Displays

Non-physical augmented displays or signage visible only to the user via wearable computing device in combination with a physical world sensor to relay personalized two-way communication information to the recipient based on facial recognition, UID or anonymous video analytics.

Home Appliances

HVAC/Window Air Conditioners/Temperature

Sensor determines pedestrian traffic flow patterns and the number of people in the room in order to conserve energy by intelligently and automatically setting to power save mode.

Doorway entrances

People counter for automatic and standard doorway entrances. IP camera sensor with built in transmitter wired/wirelessly sending analytics data to local or remote server reporting anonymous or UID demographics and traffic counts per location. Server records the collection of information.

Cash registers/Point-of-sale

Sensors embedded into POS displays/kiosks or registers that automatically attribute anonymous demographics or UID of an audience to the products being sold based on time/location. Content/pricing that can be changed and personalized based on user permissions given via the UID authentication process.

Analytics

Anonymous collection of demographic, emotion and user behavior data in a static physical space/environment or in a dynamic moving environment associated to products, interaction events (touch, click, purchases), weather, date/time or external API's in combination with a camera sensor.

Advertising

The use of a camera sensor in a physical retail store or advertisement to measure the engagement time and demographics of passersby in addition to intelligently delivered targeted messages/events.

Real-time bidding, Cost per acquisition, pay per look, Cost per engagement, Pay with face, Adaptive ads on mobile using face and AI combination.

Online video/image content analysis

Identifying attributes of specific people, scenes, objects, brands, colors, emotions, demographics, text, logos, audio within an online image or video and automatically applying tags to the content resulting in an automatic trigger event action

Automotive

Using a camera sensor to allow an individual access to vehicles, personalize dashboard setting, Entrance/start access to vehicle, Pedestrian detection, determining if driver is texting, distracted attention time or sleeping and delivers an event like vibrating chair or other alert. Blink detection—early warning alerts. Radio preference upon entering vehicle, automatic Seat Adjustments, Auto Temperature, Hands Free computing—face/voice.

Health Care

Pain recognition alerts to a health care worker based on emotions of the person face. Elderly monitoring system (no movement activity/fall down), Doctor authentication—patient information records, Permission based multi-user collaboration sessions, automated health record logs.

Home Automation

Door entrance, License plates open gate access, Energy optimization based on pedestrian traffic, Learning routines and behaviors, Music/mood/lighting and automation of blinds

Emergency response

Critical information or alerts provided to a fireman or police officer regarding a suspect or victim's identity, emotion. Road traffic/speed, Police/EMT, Fire, Utilities, Energy optimization

Security

Pedestrian detection, Lie detection, Eye dilation, Drunk/drug detection, Color of eyes (red eye)

Motion/Image Capture

3D avatar mimicking expressions and responding to feedback (see FIG. 4: Avatar)

Photo/Video:

Automatic beautification of image capture

Image/Video tagging with demographics/emotions

Hospitality/Landmarks

Guest checkin/checkout, concierge services

Real Estate

Set real estate pricing based on traffic counts/demographics

Menus

Personalized menus, recommendations, face checkin, face payment

Gaming/Entertainment

Changing game experience based on emotions, facial expressions, distance, augmented reality, perspective tracking

Sports

Dynamic engagement, gameplay and handicapping of sport scoring based on historical data of participants and their profile ID's.

Social Engagements

A sensor embedded into a wearable computing device, mobile phone or tablet that identifies a face and offers a recommendation to the user to invite connection with the person based on interest, compatibility or degrees of separation.

Specific Use cases

Probability engine for smart advertising

This use case uses a sensor to capture data listed in the Data and Information stages of a D.I.M.A system (FIG. 1). Then a primary variable is selected by the marketer, for example increased attention time to a particular advertisement. Thus the purpose of the meaning stage is to learn what types of values for other variables in the system can maximize the primary variable (in this example attention time of people captured from the camera sensor). Then machine learning techniques like supervised learning, semi supervised learning classification and regression algorithms can take as input all other variables in the system and use the primary variable as the learning label. The learning stage can constantly be updated with new information from the D.I.M.A system. This can then make recommendations on which content to play on a digital sign, smart tv, mobile device and or tablet. Content can be stored locally or remotely but the decision on what content is played next is based on the results of the probability engine. For this example a probability engine will try to maximize the attention time of people captured in the data phase of the system based on similar observations from data captured by other sensors previously (i.e. profile associations from other similar environments/use cases). Another example of a primary variable is using purchase data in connection with what products were sold and when. For this example a probability engine would make recommendations on which content to play which would maximize sales for a particular product.

Furthermore this system could also allow real time bidding of which content to play next based on market demand or the output of the probability engine (for the above example where the primary variable is attention time, or other engagement metrics). Such a system would allow content providers to access an API in real time and view outputs of the probability engine (probabilities for each piece of content in the scene, or for tags than represent and or describe content) based on the current data and information inputs to the system.

### Content Selection Process

The selection of content is split into 2 stages. The probability engine is a component that assigns probabilities (weights) to content based on the current state of the system. The state of the system is defined by tags collected from the sensor and from other sources (data and information stages shown in FIG. 1). The second component takes as input a vector of probabilities from the AI engine and decides the next content or triggered action event.

The statistical weighting will be a formula based on business goals, including pricing, frequency of content and time since the content was last displayed. Also real time bidding can be included in this process to decide which content to play next. These factors combined with the probabilities of each content will form a final decision about which content will be displayed.

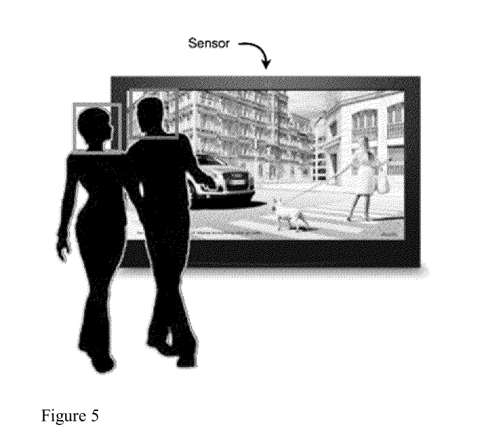

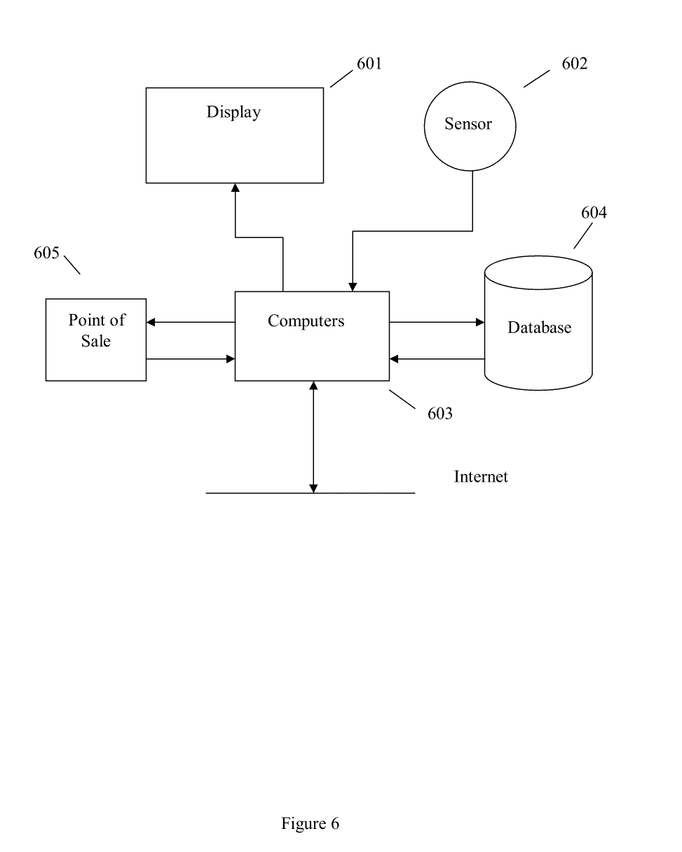

Referring to FIG. 6, the system is centered around one or more computers (603) connected to one or more databases, 604. Practitioners of ordinary skill will understand that items 603 and 604 could be split apart into separate machines operatively connected by a data network where data flows between them. In any case, the sensor (602) detects the presence of a person, as shown in FIG. 5, and transmits data to the computer, 603, which then can extract information about the viewer, for example, gender and age. The computer 603, runs a content selection algorithm relying on historical data that is stored in the database 604. The content that is selected is retrieved from the database 604, and then transmitted to the display 601, for presentation to the viewer. The sensor, 602, continues to observe the behavior of the viewer and that data is transmitted to the computer 603, which parameterizes the raw data in order to update the historical event data associated with the selected content and the viewer, that is stored in the database, 604. If the primary variable to be optimized is sales, then the point of sale device 605 is the source of behavioral data that is retrieved by the computer 603, and is further used to update the historical data in the database 604.

### Training Data

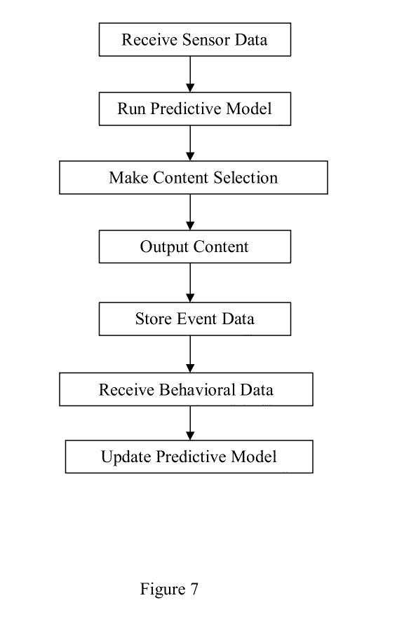

In one embodiment, the probability engine will be trained from previous data used in the D.I.M.A systems deployed in the real world, for example, as shown in FIG. 7. Once all the data is collected, the engine can be re-trained at different time periods to become more effective and learn the latest associations in the data.

Use case: Changing media content based on primary variable

### Games

In this particular use case, a user is playing a game (mobile phone/tablet or other medium) certain data from a sensor can alter the way the content is presented. Below are some examples:

An application on a smart tv, mobile phone and or tablet, can be changed based on demographic information of the user. If the user is female then the color scheme of the app can be changed. If the app is a game, the way the game is presented and or played (the functionality of the game) could be changed based on gender or age to better engage the user. This also applies to facial expression information. If a user is playing an app or game and their facial expression is analyzed then the game can be changed to better engage the user. An example is if a person is getting frustrated then the game could be changed to make it easier.

### Casino

A casino gaming device changes the exterior lighting colors, sound or display message in order to invite the user or group to participate. The sensor monitors facial features, emotions and engagement time and offer a discount, credit, coupon or other incentive if the user begins to lose interest.

### Interactive Movies

Changing content in movies. Emotional responses of users watching the movies are analyzed, the movie can alter its content to better satisfy the watchers through dynamic video narratives. For example if a movie is playing and the movie has some parts that are linked to certain emotions, then depending on how the user/users react, the movie can be altered to better engage the user/users. The data from the engagements can be used to better personalize the content to groups in future viewings.

### Education

Using a camera sensor or network of sensors within a learning environment/classroom. Sensors embedded within computers, mobile/tablets or wearable computing device to verify identity, dynamically set the difficulty of coursework, gather data on emotional expression, attention, duration and engagement and automatically adapt the content difficulty based on the previous learned method of the students. Game dynamics and functionality can be changed by a third party Moderator/teacher introducing new scenarios, challenges and rules to the student or group. This moderator is also observing, recording and measuring the non-tangible metrics of inter-personal interactions between classmates using an input device like a tablet. The measurement of an individual's team participation, problem solving, critical thinking, etc is combined with Real-time App Analytic input data, engagement data from sensors, dynamic curriculum and teacher reports.

This applies to learning content online or offline. If a sensor can analyze the emotional response of the user during the learning program, the program cannot proceed to the next level/class until the system is confident that the user has fully understood the content. The system can make such a decision by analyzing the previous responses in addition to the emotional response of the user or users.

Interactive Conversational Response with Avatars

A method of using a video recording a person's likeness and audio recording of spoken messages that cover a broad range of possible questions/responses on a given subject—including for the possibility for incorrect or non-response. Since there are so many possible event combinations data is generated from multiple sources and aggregated as defined by the recorded user. Using a combination of natural language processing, voice recognition, face recognition, emotion recognition and feature point detection to identify the persons lips and/or mouth movements, allows for the auto-tagging of events, time-based markers of specific content and subjects segmented within a conversational timeline. An audio print including tonal qualities, cadence, pitch and words allows for the recreation of video/audio interaction with a simulated avatar (person's likeness) according to rules of an intelligent system. When a user engages with the simulation the face/voice recognition feedback system defines the correct response based on the timeline of previously tagged and spoken content in addition to emotional responses. This results in a two-way simulated interactive conversation using natural speech between the user and with the person's simulated likeness on a given subject. The simulation responds to events by moving across the timeline of auto-tagged markers of subject matters and content. The user engaging with the simulation will be monitored by a sensor providing feedback into the simulation including UID, pitch/pace, emotions, pauses, date/time and engagement interest.

### Age and Gender Classification

Novel method for age and gender classification from video on mobile, smart tv and or tablet.

1. Face detection
2. Feature point detection of salient points on the face. Use eye location to align face image
3. Temporal information to find average neutral face to remove the effects of expressions.
4. Use information from step 3 to classify age and gender when the user is in neutral expression.

### Facial Recognition Verification System

Face recognition systems can sometimes be hacked by using photos. One solution is using a feature point detection system for the face and finds the salient points of the face (mouth eyes, eyebrows etc). The system can look for facial expression change of the user by analyzing the feature points to verify that photos are not been used to trick the system.

### Toys

Face recognition/analysis can be used to give toys different characters and or moods for different people interacting with the toy. An embedded camera sensor device can be inserted into a toy and facial recognition software can be used so the toy will react differently to different people. For example if the toy recognizes a user it can change its mode. Also a feedback loop with a machine learning algorithm can be used similar to the systems described above where the primary variable would be the emotion response of the user to the actions of the toy. So a child might laugh if the toy (for example a puppy) rolled over. Then the facial expression of that user can be used as a primary variable to engage that user by performing actions which maximize a happy emotional response of the subject in the future.

### AVA System on Cloud for Videos

Using a typical Anonymous Video Analytics (AVA) system on the cloud presents a number of challenges as a video can contain many different scenes. Thus for a AVA system to gather accurate analytics from a cloud based system for videos a scene changing algorithm would need to be integrated with the AVA. A method based on optical flow with a certain limit on the amount of variations between frames is proposed here to solve the problem of scene change. Such a method would also identify small movements in the camera and not classify them as scene changes. Such a system would use block based comparison of the output of the optical flow algorithm for each frame. Once a certain threshold has been exceeded for the amount of movement then the algorithm would detect a scene change. Other such methods other than optic flow could also be used. A block based approach can also be used for example texture features like edges and/or local binary patterns, which are then compared using a similarity metric to the previous frames block. This method can detect a scene change if a certain threshold is exceeded for a number of blocks in the scene. The block based approach will differentiate between foreground movements, camera movements and scene changes. So the AVA system can adjust parameters to new scenes. This allows an AVA system to maintaining the integrity of the impressions it is collecting.

### Piracy Detection in Videos

Controlling piracy of media content is a challenging problem. Our proposal is to use face detection, demographics information and face recognition to find pirated copies of visual media. Run the AVA algorithm on an original version of the content, then a time series of face information is recorded into a database. Most pirated versions of the content will look very different to the original, for example a camera recording a movie at the theater might have artifacts and a very different color representation of the content. Also the content might be captured at an angle thus any frame by frame comparison will be insufficient to matching pirated copy to the original. However by using the spatial relationship of the output AVA system correlation can be found to match the content to the original. If sufficient correlation exists between the original and the probe content then a match has been found.

The algorithm has two steps: first a time series of face data is collected to the original piece of content. Then to search if a new piece of content is a match to content in our database, a time series of face data is extracted from the probe content and a fitting process is undertaking to see if it's a match to the database. Several techniques can be used to perform the matching. This can be achieved by optimization techniques, data mining techniques and fitting algorithms etc.

### Heuristics/System Rules

The results of the AI engine can be merged with other factors and rules before a final decision is made. This stage is called the “Heuristics/Systems Rules process”.

### Example Embodiment

### Digital Signage with Attention Time as Primary Variable

If the primary variable is attention time and the system is recommending content to display. If a particular piece of content is given the highest probability by the AI engine for adult males. As adult males appear in the scene it may not be appropriate to display the content every time. Thus an external variable like last time each content was played can be used to re-weight or interpret the recommendations from the AI engine to give a final action or recommendation. So for example, if an adult male walks in to the scene and content selling beer give the highest probability then it will be display. But if another males walks into the scene immediately after, then because it has only been 1 time slot since the beer content was displayed a reweighting based inversely on the time slots since it played will force the system to display another piece of content ideally the second most weight recommendation from the AI engine. The length of a time slot can be predetermined by the system.

### Example Embodiment

### Digital Signage with Pricing Information

If pricing information is the primary variable, then the output of the AI engine for a given input will try to maximize sales and pricing data. For example if the inputs of the AI engine are gender, age and weather. Then a new impression of male, young adult and good weather could indicate this data indicates he might buy beer so the content to display would be a piece of content selling beer. Thus, the goal is the system in this example is to maximize the sales based on the input vector of gender, age and weather. The AI engine will learn the relationships between the sales data and the input vector variables.

### Example Embodiment

### Digital Signage with Real-Time or Category Tags Based Bidding

If the AI engine recommends a particular content with certain tags: For example a young adult male walks in front of the sensor. The AI engine will recommend tags like sports content. This would mean the AI engine recommends a particular type of content based on the input variables in this case young adult male and good weather. Then in the Heuristics/System Rules module can allow different companies to bid real time or offline for this particular tag. So a company can buy credit for certain tags based in the input vector like time of day and target audience. Thus companies are buying slots to display content based on the recommendations of the AI engine.

The AI engine searches through the input vectors to extract relationships to maximize the primary variable. So for example, if the primary variable is attention time, a relationship can be learnt between a piece of content about beer for certain variables in the feature vector for adult males in good weather. This content would then be recommended when a feature vector is observed in real time and contains adult males from a scene in good weather conditions.

The AI engine uses that data to improve the program's own understanding. The AI engine detects patterns in a feature vectors and adjust recommendations accordingly. The overall goal of the AI engine is to take the input vectors that include impression data and extract information from a set and transform it into an understandable structure for further use. Thus, a feature vector consistently with female adults and good weather buy sun cream, then a new feature vector contain fields adult female will indicate that the probability is high if we advertise sun cream to this person we can maximize sales.

Decision trees are a form of multiple variable analysis. See FIG. 2. Decision trees take input vectors and form nodes with thresholds for each of N dimensions of an impression. For example an input vector of gender, age and weather information as shown in the figure of a decision tree in FIG. 2. The initial decision tree is trained from impressions tied to these variables. Nodes for each of the N variables learn threshold values to as to produce an outcome similar to training data. Threshold values for each node are learned to maximize or minimize a regression variable (primary variable). The values in the input vector are used to estimate the likely value in the primary variable, in this case, the example of what content to play. The feedback occurs when this decision tree is used on future impressions to try and predict outcomes based on historically trained impressions. In the example this means from historical data male child in some weather conditions pay attention to sports content. This is an example of how an AI algorithm can deal with the input features and recommend an outcome, in this example what category of content to display. A tree is learnt from training data of impressions from real world examples. Then the tree will make recommendations based on the relationships learnt. So for example given the above diagram given a male child and certain weather type the recommendation will be to display content tagged with sports or clothes for children depending on the weather variable.

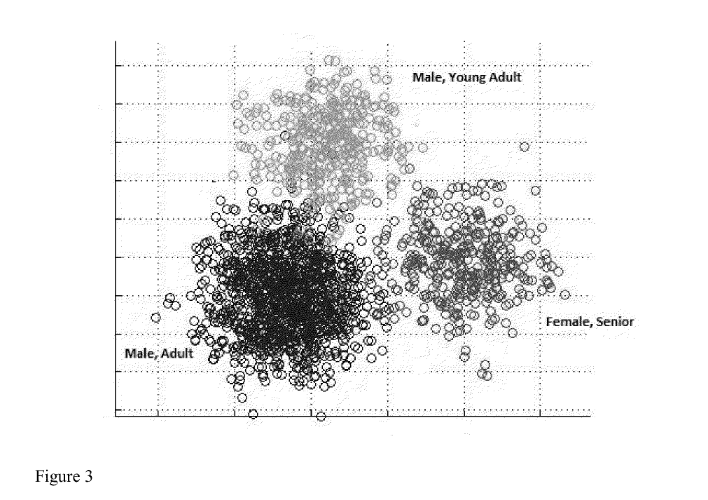

In another embodiment, invention constructs a vector of N variables, each nth entry of being the data representing the nth factor for an interaction. For example, a vector of length three could be (viewing time, weather, sex). The plurality of vectors collected by the system will create clusters of defined points in an N space. See FIG. 3. By defining a pre-defined spatial region in the N space, one defines a range of positions of the vector that meet a predetermined condition represented by the boundary of the region. For example, in one corner of the N space, the vectors are male, the weather is good, and the viewing time short. This region itself can be correlated with sales activity, for example frequent sales of sports equipment. In another corner, the vectors are female, the weather is bad and the viewing time long. Vectors in this region may correlate with subsequent visits to a spa. By defining an acceptable boundary to the region, one can determine if a new interaction falls into one category or the other and thereby make a prediction for that viewer what kinds of subsequent purchases are likely, or what advertising is appropriate based on the past activity of other viewers.

In another embodiment, vector endpoint correlation can be used, whether by linear correlation or fuzzy sets. For example, referring to FIG. 3, a linear correlation in N dimensions over the N variables to find some kind of linear function, where the primary variable is one of the dimensions. Thus, the system creates a linear function that can be used to find ranges of the other variables that will increase (or decrease) the primary variable.

In another embodiment, a discrete partial derivative in N dimensions is performed, so its d/dv, where v is the primary variable. Then the system performs a hill climbing algorithm looking for the highest point (or lowest point) that the primary variable v has in the space.

In yet another embodiment, a set of heuristic logic rules can be constructed that respond to the input variables in the form of an expert-system. For example: “If Season=Summer=>Beach Ad.” And “If Beach Ad and Male Viewer=>Beach Ad=Beer Ad”. Each time an event occurs, the rule system responds to the event, and the output of the rule system are changes to the selected media. Heuristic rules are input as marketing research uncovers various situations that need to be addressed by the system. In yet another embodiment, the system uncovers factors that drive the primary variable and as a result, heuristic rules are created automatically that maximize the primary variable.

Any example of machine adaptation or learning, whether heuristic, statistical or determinative methods can be used in the AI module of the system. In other embodiments, the feedback engine isn't necessarily an AI engine. Any appropriately configured machine learning or data-mining algorithm can be used. The term feedback refers to a function (AI, machine learning or data-mining) to make a decision in real time, which is trained from historically data or impressions. This training can take place continually, at the end of every day, week or any time period. So for example the if the function in the AI engine is trained at the end of each day, then the feedback from the previous days data will be included in all decisions made with the updated function today. Any machine learning algorithm can form part of this feedback process by definition as long as it has been trained by historical data. The feedback part of the system is present by the fact any machine learning algorithm is used and tied to a primary variable from previous observations.

### Operating Environment:

The system is typically comprised of a central server that is connected by a data network to a user's computer. The central server may be comprised of one or more computers connected to one or more mass storage devices. The precise architecture of the central server does not limit the claimed invention. In addition, the data network may operate with several levels, such that the user's computer is connected through a fire wall to one server, which routes communications to another server that executes the disclosed methods. The precise details of the data network architecture do not limit the claimed invention. Further, the user's computer may be a laptop or desktop type of personal computer. It can also be a cell phone, smart phone or other handheld device. The precise form factor of the user's computer does not limit the claimed invention. In one embodiment, the user's computer is omitted, and instead a separate computing functionality provided that works with the central server. This may be housed in the central server or operatively connected to it. In this case, an operator can take a telephone call from a customer and input into the computing system the customer's data in accordance with the disclosed method. Further, the user may receive from and transmit data to the central server by means of the Internet, whereby the user accesses an account using an Internet web-browser and browser displays an interactive web page operatively connected to the central server. The central server transmits and receives data in response to data and commands transmitted from the browser in response to the customer's actuation of the browser user interface. Some steps of the invention may be performed on the user's computer and interim results transmitted to a server. These interim results may be processed at the server and final results passed back to the user.

The invention may also be entirely executed on one or more servers. A server may be a computer comprised of a central processing unit with a mass storage device and a network connection. In addition a server can include multiple of such computers connected together with a data network or other data transfer connection, or, multiple computers on a network with network accessed storage, in a manner that provides such functionality as a group. Servers can be virtual servers, each an individual instance of software operating as an independent server but housed on the same computer hardware. Practitioners of ordinary skill will recognize that functions that are accomplished on one server may be partitioned and accomplished on multiple servers that are operatively connected by a computer network by means of appropriate inter process communication. In addition, the access of the website can be by means of an Internet browser accessing a secure or public page or by means of a client program running on a local computer that is connected over a computer network to the server. A data message and data upload or download can be delivered over the Internet using typical protocols, including TCP/IP, HTTP, SMTP, RPC, FTP or other kinds of data communication protocols that permit processes running on two remote computers to exchange information by means of digital network communication. As a result a data message can be a data packet transmitted from or received by a computer containing a destination network address, a destination process or application identifier, and data values that can be parsed at the destination computer located at the destination network address by the destination application in order that the relevant data values are extracted and used by the destination application.

It should be noted that the flow diagrams are used herein to demonstrate various aspects of the invention, and should not be construed to limit the present invention to any particular logic flow or logic implementation. The described logic may be partitioned into different logic blocks (e.g., programs, modules, functions, or subroutines) without changing the overall results or otherwise departing from the true scope of the invention. Oftentimes, logic elements may be added, modified, omitted, performed in a different order, or implemented using different logic constructs (e.g., logic gates, looping primitives, conditional logic, and other logic constructs) without changing the overall results or otherwise departing from the true scope of the invention.

The method described herein can be executed on a computer system, generally comprised of a central processing unit (CPU) that is operatively connected to a memory device, data input and output circuitry (IO) and computer data network communication circuitry. Computer code executed by the CPU can take data received by the data communication circuitry and store it in the memory device. In addition, the CPU can take data from the I/O circuitry and store it in the memory device. Further, the CPU can take data from a memory device and output it through the IO circuitry or the data communication circuitry. The data stored in memory may be further recalled from the memory device, further processed or modified by the CPU in the manner described herein and restored in the same memory device or a different memory device operatively connected to the CPU including by means of the data network circuitry. The memory device can be any kind of data storage circuit or magnetic storage or optical device, including a hard disk, optical disk or solid state memory. The IO devices can include a display screen, loudspeakers, microphone and a movable mouse that indicate to the computer the relative location of a cursor position on the display and one or more buttons that can be actuated to indicate a command.

Examples of well known computing systems, environments, and/or configurations that may be suitable for use with the invention include, but are not limited to, personal computers, server computers, hand-held, laptop or mobile computer or communications devices such as cell phones and PDA's, multiprocessor systems, microprocessor-based systems, set top boxes, programmable consumer electronics, network PCs, minicomputers, mainframe computers, distributed computing environments that include any of the above systems or devices, and the like. The computer can operate a program that receives from a remote server a data file that is passed to a program that interprets the data in the data file and commands the display device to present particular text, images, video, audio and other objects. The program can detect the relative location of the cursor when the mouse button is actuated, and interpret a command to be executed based on location on the indicated relative location on the display when the button was pressed. The data file may be an HTML document, the program a web-browser program and the command a hyper-link that causes the browser to request a new HTML document from another remote data network address location.

The Internet is a computer network that permits customers operating a personal computer to interact with computer servers located remotely and to view content that is delivered from the servers to the personal computer as data files over the network. In one kind of protocol, the servers present webpages that are rendered on the customer's personal computer using a local program known as a browser. The browser receives one or more data files from the server that are displayed on the customer's personal computer screen. The browser seeks those data files from a specific address, which is represented by an alphanumeric string called a Universal Resource Locator (URL). However, the webpage may contain components that are downloaded from a variety of URL's or IP addresses. A website is a collection of related URL's, typically all sharing the same root address or under the control of some entity.

Computer program logic implementing all or part of the functionality previously described herein may be embodied in various forms, including, but in no way limited to, a source code form, a computer executable form, and various intermediate forms (e.g., forms generated by an assembler, compiler, linker, or locator.) Source code may include a series of computer program instructions implemented in any of various programming languages (e.g., an object code, an assembly language, or a high-level language such as FORTRAN, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The invention may be described in the general context of computer-executable instructions, such as program modules, being executed by a computer. Generally, program modules include routines, programs, objects, components, data structures, etc., that perform particular tasks or implement particular abstract data types. The computer program and data may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed hard disk), an optical memory device (e.g., a CD-ROM or DVD), a PC card (e.g., PCMCIA card), or other memory device. The computer program and data may be fixed in any form in a signal that is transmittable to a computer using any of various communication technologies, including, but in no way limited to, analog technologies, digital technologies, optical technologies, wireless technologies, networking technologies, and internetworking technologies. The computer program and data may be distributed in any form as a removable storage medium with accompanying printed or electronic documentation (e.g., shrink wrapped software or a magnetic tape), preloaded with a computer system (e.g., on system ROM or fixed disk), or distributed from a server or electronic bulletin board over the communication system (e.g., the Internet or World Wide Web.)

The invention may also be practiced in distributed computing environments where tasks are performed by remote processing devices that are linked through a communications network. In a distributed computing environment, program modules may be located in both local and remote computer storage media including memory storage devices. Practitioners of ordinary skill will recognize that the invention may be executed on one or more computer processors that are linked using a data network, including, for example, the Internet. In another embodiment, different steps of the process can be executed by one or more computers and storage devices geographically separated by connected by a data network in a manner so that they operate together to execute the process steps. In one embodiment, a user's computer can run an application that causes the user's computer to transmit a stream of one or more data packets across a data network to a second computer, referred to here as a server. The server, in turn, may be connected to one or more mass data storage devices where the database is stored. The server can execute a program that receives the transmitted packet and interpret the transmitted data packets in order to extract database query information. The server can then execute the remaining steps of the invention by means of accessing the mass storage devices to derive the desired result of the query. Alternatively, the server can transmit the query information to another computer that is connected to the mass storage devices, and that computer can execute the invention to derive the desired result. The result can then be transmitted back to the user's computer by means of another stream of one or more data packets appropriately addressed to the user's computer. In one embodiment, the relational database may be housed in one or more operatively connected servers operatively connected to computer memory, for example, disk drives. The invention may be executed on another computer that is presenting a user a semantic web representation of available data. That second computer can execute the invention by communicating with the set of servers that house the relational database. In yet another embodiment, the initialization of the relational database may be prepared on the set of servers and the interaction with the user's computer occur at a different place in the overall process.

The described embodiments of the invention are intended to be exemplary and numerous variations and modifications will be apparent to those skilled in the art. All such variations and modifications are intended to be within the scope of the present invention as defined in the appended claims. Although the present invention has been described and illustrated in detail, it is to be clearly understood that the same is by way of illustration and example only, and is not to be taken by way of limitation. It is appreciated that various features of the invention which are, for clarity, described in the context of separate embodiments may also be provided in combination in a single embodiment. Conversely, various features of the invention which are, for brevity, described in the context of a single embodiment may also be provided separately or in any suitable combination. It is appreciated that the particular embodiment described in the Appendices is intended only to provide an extremely detailed disclosure of the present invention and is not intended to be limiting.

The foregoing description discloses only exemplary embodiments of the invention. Modifications of the above disclosed apparatus and methods which fall within the scope of the invention will be readily apparent to those of ordinary skill in the art. Accordingly, while the present invention has been disclosed in connection with exemplary embodiments thereof, it should be understood that other embodiments may fall within the spirit and scope of the invention as defined by the following claims.

What is claimed:

1. A system of one or more computing devices operatively connected to transfer data for presenting media content to a viewer facing a display comprising:
a display component adapted to display one or more content items on the display;
a sensor component adapted to detect and record one or more characteristics of the viewer of the display;
a selection component comprised of past viewer behavioral data stored in a data storage system where the selection component is adapted to receive the detected viewer characteristics, and use the received characteristics and stored behavioral data to determine a selection of content to be displayed on the display component.

2. The system of claim 1 where the selection component is further adapted to:
Determine the selection of content that most likely will maximize a predetermined primary variable.

3. The system of claim 2 where the primary variable is the amount of time the viewer faces the display.

4. The system of claim 2 further comprising a component adapted to receive one or more point of sale data from one or more locations.

5. The system of claim 4 where the primary variable is a revenue rate.

6. The system of claim 1 where the selection component is further receives aggregated behavioral data of many viewers.

7. The system of claim 2 where the selection component is further adapted to receive heuristic rules and to also use the rules to determine the selection.

8. The system of claim 2 where the selection component is further adapted to determine content that is of an advertising type that maximizes the engagement by the viewer.

9. The system of claim 1 further comprising a database comprised of a profile data structure associated with the selected content, said profile being adapted to have stored into at least some of the detected data.

10. The system of claim 2 where the selection component is further comprised of a data structure that stores historical received behavioral data of the viewer and additional viewers and a predictive model that uses the stored behavioral data.

11. The system of claim 10 where the predictive model is adapted to use historical viewer behavior to determine an optimal content selection for the viewer.

12. The system of claim 2 further comprising an output device adapted to output a list of selected product items determined from the predictive model.

13. The system of claim 2 where the primary variable is a unique relative score derived from expression of the viewer's face.

14. The system of claim 10 where the predictive model uses random forest data mining in its determination.

15. The system of claim 10 where the predictive model uses for its determination process at least one of: ferns, boosting, support vector machines, neural networks, regression analysis, or Bayes networks.

16. A method of automatically selecting content for display on a display screen watched by a viewer comprising:
Detecting one or more characteristics of the viewer;
Retrieving historical data comprised of detected characteristics of other viewers; and
In dependence on the detected and retrieved characteristics, determining using a data analysis function content to be displayed on the screen, where the determining step is a feedback process that adjusts the selection function to maximize a primary variable.

17. The method of claim 16 where the determining step is comprised of:
Using a probability engine that assigns a vector comprised of a plurality of probability weights to content based on the current state of the system, where the weights are determined using a formula based on pre-determined goals and the state is defined by a plurality of tags collected from at least one sensor and other data sources; and
Selecting the content using the vector of probabilities.

18. The method of claim 17 where the content is a computer game, the detected characteristic is facial expression information related to the viewer and the primary variable is data representing the level of viewer frustration.

19. The method of claim 17 where the content is a computer game, the detected characteristic is facial expression information related to the viewer and the primary variable is data representing the level of viewer frustration.

20. The method of claim 17 where the content is a casino game displayed on a casino gaming device, the detected characteristic is facial expression information related to the viewer and the primary variable is data representing the level of viewer engagement.

21. The method of claim 17 where the content is a movie, the detected characteristic is facial expression information related to the viewer and the primary variable is data representing the level of viewer emotion and further comprising altering the movie presentation in dependence on the primary variable.

22. The method of claim 17 where the content is educational materials, the detected characteristic is comprehension information related to the viewer and the primary variable is data representing the level of viewer comprehension and further comprising altering the educational material presentation in dependence on the primary variable.

23. The method of claim 17 where the content is the behavior of a toy, the detected characteristic is facial expression information related to the viewer and the primary variable is data representing the viewer mood.

24. The method of claim 17 where the content is an advertisement, the detected characteristic is facial expression information related to the viewer and the primary variable is data representing a revenue rate and the method further comprising determining if the selected content should be displayed in further dependence on the time period between the current time and the time of the last presentation of the content.

25. The method of claim 24 where the selection is further dependent on a vector of viewer gender, viewer age and current weather.

26. The method of claim 10 where the predictive model uses a decision tree for multiple variable analysis, said decision tree comprised of nodes, each node associated with a threshold value for each of a pre-determined plurality of dimensions.

27. The method of claim 26 further comprising: modifying the predictive module using training data representing input vectors and desired decision tree output in order that the predictive model automatically produce outcomes that approximate the training data.

28. The method of claim 10 where the input data and output data to the predictive model is represented by vectors and the predictive model uses linear correlation across the number of dimensions represented by the vectors.

29. The method of claim 10 where the input data to the predictive model is represented by a vector with corresponding dimensions, the predictive model is comprised of a plurality of data values representing the plurality of first partial derivative of the primary variable corresponding to each dimension of the vector and the method is further comprised of executing a hill-climbing algorithm to maximize the primary variable using the plurality of first derivatives.

30. The method of claim 1 where the selection component is comprised of an expert system utilizing heuristic rules derived from the stored past behavioral data.

31. A computer system for presenting media content to a viewer facing a display comprising:
a component adapted to display one or more advertising content on the display;
a component adapted to detect and record one or more characteristics of the viewer of the display;
a calculation component adapted to receive the detected viewer characteristics, retrieve past viewer behavior and other stored variables and determine an advertisement to be displayed on the display component to the detected viewer.

32. The system of claim 31 where the calculation component is further adapted to:
receive the detected data, the retrieved data and then operate any one of: machine learning, data mining, linear correlation, hill climbing, heuristic rule processing, in order to maximize a predetermined primary variable; and
use the output of the operation to select an advertisement to be displayed.

33. A method of automatically selecting advertising for display on a display screen watched by a viewer comprising:
Detecting one or more characteristics of the viewer;
Retrieving historical data comprised of detected characteristics of other viewers; and
In dependence on the detected and retrieved characteristics, determining using a data analysis function an advertisement to be displayed on the screen, where the determining step is a feedback process that adjusts the selection function to maximize a primary variable.
